(19) United States
(12) Patent Application Publication
(10) Pub. No.: US 2006/0265358 A1
(43) Pub. Date: Nov. 23, 2006

(54) Method and apparatus for providing information to search engines

(76) Inventors: Junichi Hara, Cupertino, CA (US); Shoji Kodama, Kanagawa (JP); Akira Yamamoto, Kanagawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/130,238

(22) Filed: May 17, 2005

(51) Int. Cl. G06F 17/30; G06F 7/00

(52) U.S. Cl. 707/3

(57) ABSTRACT

For a system having file servers or network attached storage (NAS) systems with storage area network (SAN) connectivity and search engines, when the search engine retrieves files in volumes used by host computers, the search engine instructs the NAS system to export the files in the volumes. The NAS system instructs the host computers to flush all the data cached in memory to the volumes and suspend all the I/O processes to the volumes. Then, the NAS system mounts the volumes and exports the files in the volumes used by the host computers to the search engine via a LAN. The search engine retrieves the files in the volumes via LAN using NFS/CIFS protocol, and creates search indices. After the search engine completes retrieving all the files in the volumes, the NAS system unexports and unmounts the volumes and the host computers resume I/O process to the volumes.

### BACKGROUND OF THE INVENTION

1. Field of the Invention

The present invention is related to Network Attached Storage (NAS) systems having a feature of Storage Area Network (SAN) connectivity.

2. Description of the Related Art

Recently, since the amount of data stored in information systems in companies is increasing at an explosive rate, the technology to find required information among this data is gaining more importance. To meet this requirement, search engines have been created and are widely used.

A search engine is designed to find required information quickly among the large amount of data stored in servers such as file servers, web servers, databases, etc. Since these servers are usually deployed independently and provided in a dispersed manner in a network, the search engine must retrieve data from each server via a network and generate search indices in advance so as to be able to perform searching quickly. When users instruct the search engine to find some information among the data, the search engine tries to find the information by referring to the search indices. However, when the search engine retrieves data from each server, it burdens each server's CPU.

Examples in the prior art include U.S. Pat. No. 6,370,626(B1) to Gagne et al., entitled “Method and Apparatus for Independent and Simultaneous Access to a Common Data Set”, the entire disclosure of which is hereby incorporated by reference. One well known search engine is “Google” (http://www.google.com/enterprise/gsa/index.html). Another search engine can be located at http://www.fastsearch.com/.

### BRIEF SUMMARY OF THE INVENTION

An object of the present invention is to provide a method and apparatus to reduce the load on file servers caused by data retrieval by search engines. The system disclosed in the invention includes a search engine, host computers, and a NAS (Network Attached Storage) system. The NAS system used in this invention may simultaneously have SAN (Storage Area Network) connectivity. The CPU in the NAS system performs management of volumes within the NAS system, file serving via LAN (Local Area Network) using protocols such as NFS (Network File System) or CIFS (Common Internet File system) protocol, and processes read/write requests from host computers via SAN using fibre channel protocol, or the like. The host computers use the volumes in the NAS system via SAN. Different operating systems (OSs) such as Windows or Linux may be running on each host computer. Therefore, different file system data such as NTFS or EXT2 can be stored in each volume.

According to one embodiment, when the search engine retrieves files in the volumes used by the host computers, the search engine instructs the NAS system to export the files in the volumes. When receiving the instruction from the search engine, the NAS system instructs the host computers to flush all the data cached in the memory to the volumes and suspend all the I/O processes to the volumes. Then, the NAS system mounts the volumes and exports the files in the volumes used by the host computers to the search engine via a LAN, and the search engine retrieves the files in the volumes via a LAN using NFS/CIFS protocol, and makes search indices. After the search engine completes retrieving all the files in the volumes, the NAS system unexports and unmounts the volumes. Then, the host computers resume the I/O process.

In another embodiment, when receiving the instruction from the search engine, the NAS system instructs the host computers to flush all the data cached in the memory to the volumes and suspend I/O process. Then, the NAS system prepares shadow volumes of the volumes. After completing preparing the shadow volumes, the NAS system splits the shadow volumes and instructs the host computers to resume the I/O processes. Then the NAS system mounts and exports the shadow volume of the volumes. In this manner, the period of suspending I/O to the volumes on host computers can be shortened compared to previous embodiment because the host computers don't have to suspend I/O during the file retrieval by the search engine.

In yet another embodiment, the search engine instructs the NAS system to prepare shadow volumes of the volumes in advance that contains files the search engine is going to retrieve. When receiving the instruction from the search engine again, the NAS system instructs the host computers to flush all the data cached in the memory to the volumes and suspend I/O processes. Then, the NAS system splits the shadow volumes and instructs the host computers to resume the I/O processes. Then, the NAS system mounts and exports the shadow volume of the volumes. In this manner, the period of suspending I/O processes to the volumes on host computers can be shortened compared to the previous embodiment because the NAS system does not have to prepare shadow volumes while I/O processes from the host computers are suspended.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an overall system configuration of the present invention.

FIG. 2 illustrates a functional diagram of a first embodiment of the present invention.

FIG. 3 illustrates a volume management table according to a first embodiment of the present invention.

FIG. 4 illustrates a table of host names for retrieving files.

FIG. 5 illustrates the normal operation of file retrieval relating to the first embodiment of the present invention.

FIG. 6 illustrates an operation of file retrieval according to a first embodiment of the present invention.

FIG. 7 illustrates a flow diagram of file retrieval according to the first embodiment of the present invention.

FIG. 8 illustrates a functional diagram of a second embodiment of the present invention.

FIG. 9 illustrates a normal operation of file retrieval relating to the second embodiment of the present invention.

FIG. 10 illustrates an operation of generating a shadow volume according to the second embodiment of the present invention.

FIG. 11 illustrates an operation of file retrieval according to the second embodiment of the present invention.

FIG. 12 illustrates a flow diagram of file retrieval according to the second embodiment of the present invention.

FIG. 13 illustrates a functional diagram of a third embodiment of the present invention.

FIG. 14 illustrates a flow diagram of preparation of file retrieval.

FIG. 15 illustrates a volume management table according to a third embodiment of the present invention.

FIG. 16 illustrates a normal operation after preparing shadow volumes.

FIG. 17 illustrates an operation of splitting shadow volumes.

FIG. 18 illustrates file retrieval.

FIG. 19 illustrates a flow diagram of file retrieval in the case of splitting a shadow volume.

FIG. 20 illustrates an example layout of file system data.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views.

### First Embodiment

System Configuration:

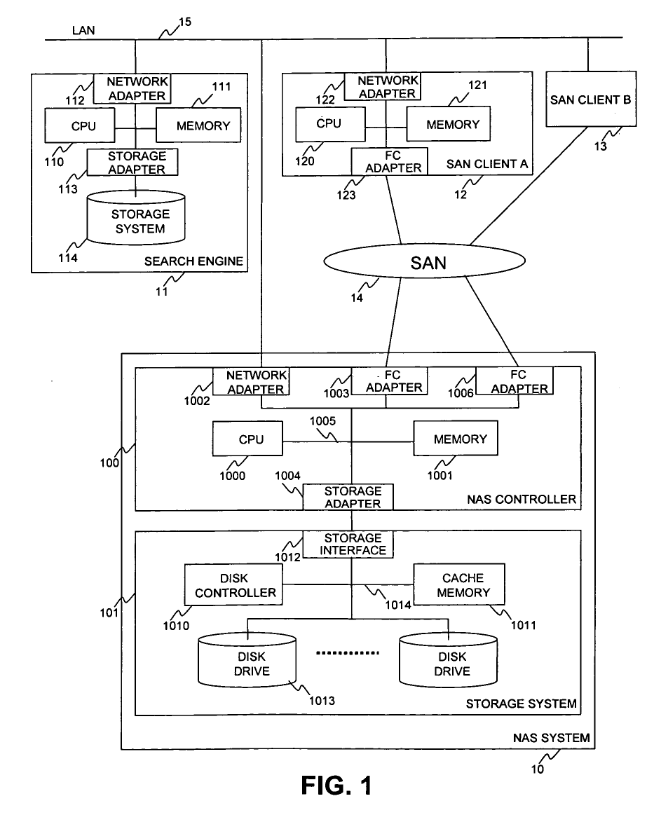

FIG. 1 shows an example of the system in which the method and apparatus of this invention are applied. The system is composed of a NAS system 10, a search engine 11, and SAN clients 12 and 13. NAS system 10 includes NAS controller 100 and storage system 101. The NAS controller 100 includes CPU 1000, memory 1001, network adapter 1002, fibre channel (FC) adapters 1003, 1006, and storage adapter 1004. The storage system 101 includes disk controller 1010, cache memory 1011, storage interface 1012, and disk drives 1013. NAS controller 100 and storage system 101 are connected to each other via storage adapter 1004 and storage interface 1012. Here, interfaces such as fibre channel or SCSI can be used for storage interface 1012. In those cases, a host bus adapter (HBA) is used for storage adapter 1004. Also, storage system 101 can be externally deployed and connected to NAS controller 100 via these interfaces. The components of NAS controller 100 communicate internally via communication connection 1005, while the components of storage system 101 communicate internally via communication connection 1014. NAS system 10 is connected to search engine 11 and SAN clients 12 and 13 via network adapter 1002 and LAN 15, and is also connected to SAN clients 12 and 13 via FC adapters 1003, 1006 and SAN 14. Some of the programs realizing this invention run on the NAS system 10 using CPU 1000 in NAS controller 100.

Search engine 11 includes CPU 110, memory 111, network adapter 112, storage adapter 113, and storage system 114. Search engine 11 is connected to the NAS system 10 via network adapter 112. Storage system 114 has the same components as the storage system 101, and can be externally deployed and connected. Some of the programs realizing this invention run on search engine 11 using CPU 110.

Each of SAN clients 12 and 13 includes CPU 120, memory 121, network adapter 122, and FC adapter 123. Each of SAN clients 12 and 13 is connected to NAS system 10 via FC adapter 123, and is also connected to NAS system 10 via network adapter 122. Some of the programs realizing this invention run on SAN clients 12 and 13 using CPU 120.

Functional Diagram:

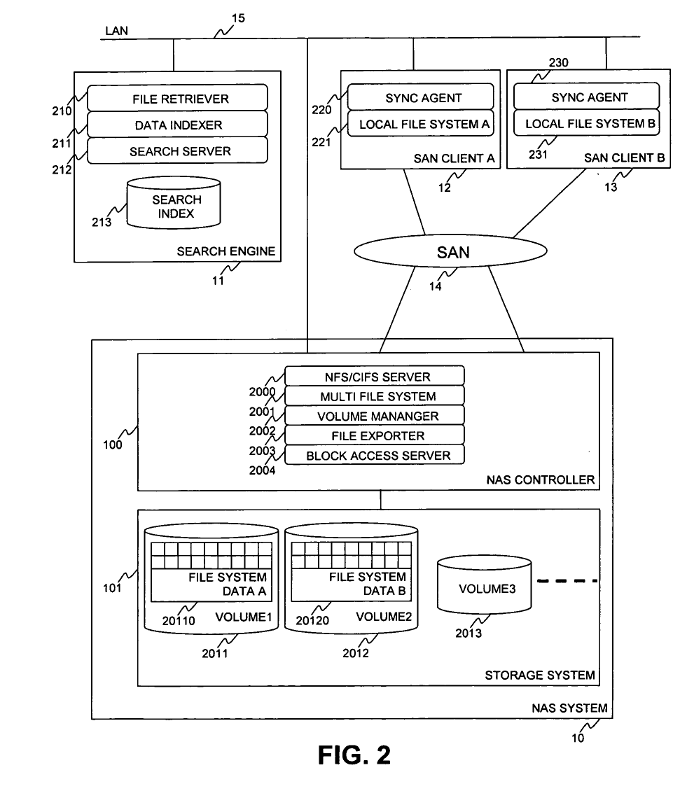

FIG. 2 shows a functional diagram of the system in the first embodiment.

The NAS controller will now be described in more detail. In NAS controller 100 of NAS system 10, there are an NFS/CIFS server 2000, a multi-file system 2001, a volume manager 2002, a file exporter 2003, and a block access server 2004.

NFS/CIFS server 2000 exports files (makes the files accessible through a file system protocol such as NFS or CIFS) in volumes that multi-file system 2001 mounts in accordance with an instruction by an administrator of NAS system 10 or by file exporter 2003. When receiving file system protocol messages from search engine 11 or other NAS clients (not shown in FIG. 2) connected to LAN 15, NFS/CIFS server 2000 interprets the messages and issues appropriate file I/O requests to multi-file system 2001.

Multi-file system 2001 receives file I/O requests from NFS/CIFS server 2000, and issues appropriate block I/O requests to volume manager 2002. Also, in accordance with an instruction by an administrator of NAS system 10 or by file exporter 2003, multi-file system 2001 looks into volumes and distinguishes what file system data the volumes contain, and mounts the volumes to make files in the volumes accessible from NFS/CIFS server 2000.

Volume manager 2002 creates one or more volumes 2011, 2012, 2013 using one or more disk drives 1013 (shown in FIG. 1) in storage system 101. Also, volume manager 2002 receives block I/O requests from NFS/CIFS server 2000 and block access server 2004, and issues appropriate block I/O requests to the volumes.

File exporter 2003 receives an “EXPORT” message from a file retriever 210 in search engine 11. Upon receiving the “EXPORT” message, file exporter 2003 sends a “SYNC” message to Sync Agent 220 or 230 in SAN client 12 or 13, respectively. Also, file exporter 2003 instructs multi-file system 2001 to mount volumes and instructs NFS/CIFS server 2000 to export files in the volumes mounted by multi-file system 2001.

Block access server 2004 processes I/O requests received via SAN 14. When receiving the I/O requests, block access server 2004 issues block I/O requests to volume manager 2002.

Next, search engine 11 will be described in more detail. Search engine 11 includes file retriever 210, a data indexer 211, and a search server 212.

File retriever 210 sends an “EXPORT” message to NAS system 10, as mentioned above. Also, file retriever 210 retrieves files from NAS system 10 using file system protocol (e.g., NFS or CIFS) via a LAN, and passes them to data indexer 211. Data indexer 211 creates search indices 213 of the files retrieved by file retriever 210. Search server 212 receives and interprets search queries from search clients (not shown in FIG. 2) connected to LAN 15, and executes searches in the search indices 213 made by data indexer 211. Also, search server 212 sends back the results to these search clients.

Each of the SAN clients 12 and 13 include a sync agent (220 and 230) and a local file system (local file system A 221 in SAN client A 12, and local file system B 231 in SAN client B 13). Local file system A 221 and local file system B 231 are different from each other, such as NTFS and EXT2, for example.

Sync agent 220 instructs local file system A 221 to flush all the data cached in memory 121 (shown in FIG. 1) and suspend all the write I/O processes to the volumes in NAS system 10 when receiving a “SYNC” message from NAS system 10. Also, it returns a WWN (World Wide Name) and LUN (Logical Unit Number) of the volume that the SAN client 12 is using. Local file system A 221 flushes all the data cached in memory 121, and suspends all the write I/O processes to the volumes in NAS system 10 in accordance with the instruction from Sync Agent 220.

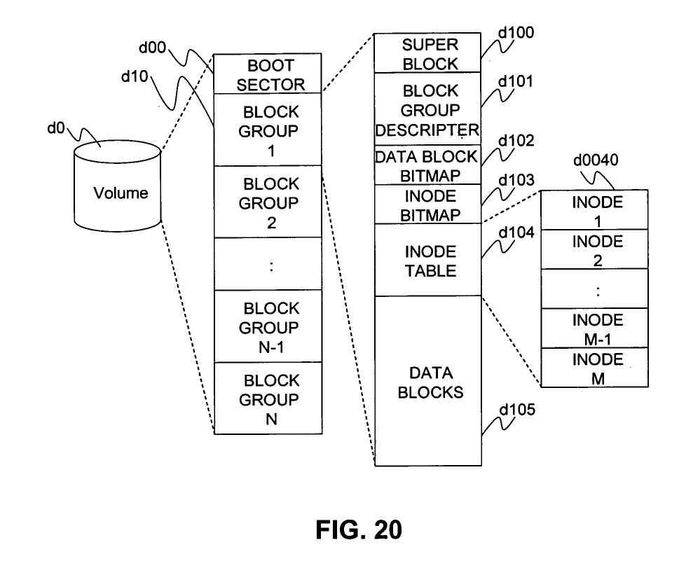

Next the file system data layout will be explained in conjunction with FIG. 20. FIG. 20 shows an example of how file systems on host computers (like local file system A 221 and local file system B 231) store data in volumes. The example is from the EXT2 file system of Linux. A Boot Sector d00 commonly exists whatever file system is used. Boot Sector d00 is used to store data needed to boot a host computer. Even if the volume d0 is not used to boot a host computer, Boot Sector d00 exists. It contains, for example, a program to boot the host computer if needed and which file system's data is stored in the volume, etc. Therefore, it is possible to determine which file system's data is stored in the volume d0 by looking into the Boot Sector d00 in the volume. How the rest of the volume d0 is used depends on the kind of file system.

The EXT2 file system divides the rest of the volume into block Groups d10. Each block group d10 contains super block d100, block group descriptor d101, data block bitmap d102, inode bitmap d103, inode tables d104, and data blocks d105. Super block d100 is used to store the location information of block groups d10. Every block group d10 has the same copy of super block d100. Block group descriptor d101 stores the management information of the block group d10. Data block bitmap d102 shows which data blocks d105 are in use. In a similar manner, inode bitmap d103 shows which inodes d0040 in inode table d104 are in use.

Now, the function of delayed write cache will be explained. Generally, writing to storage systems (or disk drives) is much slower than writing to memories. To respond faster, file systems usually delay writing to volumes in storage systems and keep (or cache) the changed data in memory for a certain period. By doing so, file systems try to merge several write I/O request into one write I/O request. For example, when a write I/O request comes to the same block cached in the memory, the previous write I/O request no longer has to be written to storage systems. But, there is a side effect from delaying writing. The consistency of file system data in a volume mounted by a host cannot be guaranteed because some data may be cached in memory on the host. So, when host B mounts file system data in a volume while host A mounts the file system data, all the data cached in host A must be flushed to the volume and all the I/O requests from the file system on host A is stopped. All the cached data is flushed when a host unmounts file system data in a volume. Also, when a user or an application on the host executes a “sync” command, all the cached data is flushed to the volume.

Accessing a volume via SAN will now be described. When a SAN client accesses a volume in a storage system via SAN using FC protocol, the client specifies operation type (READ or WRITE), WWN (World Wide Name), LUN (Logical Unit Number), and Logical Block Address (LBA) in an I/O request. Here, the WWN and the LUN that the client specifies are the storage system's WWN and LUN. WWN is a unique name assigned to each FC adapter. LUN is a number assigned to each volume. WWN must be unique worldwide, but LUN is unique only in volumes exported through the same FC adapter. LBA is an address of a block in a volume.

According to the present invention, the requests from SAN clients are processed by block access server 2004. When receiving the requests, block access server 2004 issues block I/O requests to volume manager 2002, and volume manager 2002 issues the READ or WRITE I/O commands to the blocks (determined by LBA) within the volumes (determined by WWN and LUN).

In FIG. 2, it is assumed that SAN client A 12 is using volume 1 2011, and SAN client B 13 is using volume 2 2012. So, volume 1 2011 contains file system data A 20110, and volume 2 2012 contains file system data B 20120.

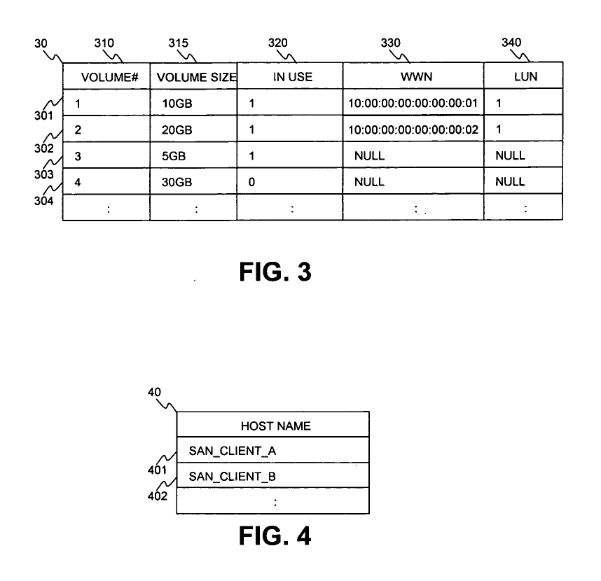

FIG. 3 shows an example of a table 30 to manage the volumes in storage system 101 in NAS system 10. The table is managed by volume manager 2002. The volume# column 310 corresponds to the volumes in storage system 101. This number is used internally in NAS system 10 to manage the volumes. Each volume number is a unique number assigned to each volume created by volume manager 2002 using disk drives 1013. In FIG. 3, volume# 1 corresponds to volume 1 2011, volume# 2 to volume 2 2012, and volume# 3 to volume 3 2013. Volume Size column 315 shows the size of each volume.

The IN USE column 320 shows whether the volume is in use or not. The numeral “1” will be set here if the volume is in use, and “0” will be set here if the volume is not in use.

The WWN column 330 shows which FC adapter the volume is exported through. In FIG. 3, 10:00:00:00:00:00:00:01 is a WWN of FC adapter 1003, and 10:00:00:00:00:00:00:02 is a WWN of FC adapter 1006. When the volume is used internally in NAS system 10, null will be set here.

The LUN column 340 shows what LUN number is assigned to the volume. When the volume is used internally in NAS system 10, null will be set here. In case of FIG. 3, the row 301 shows that volume 1 2011 (volume# 1) is exported through FC adapter 1003 (WWN: 10:00:00:00:00:00:00:01), and that LUN 1 is assigned to volume 1 2011. The row 302 shows that volume 2 2012 (volume# 2) is exported through FC adapter 1006 (WWN: 10:00:00:00:00:00:00:02), and that LUN 1 is assigned to volume 2 2012. Also, the row 303 shows that volume 3 2013 (volume#: 3) is used internally in NAS system 10, and the row 304 shows that the volume# 4 is created but not in use. Here, NAS system 10 doesn't know which host computer is using which volume. However, if WWN and LUN are informed by the host computer, NAS system 10 can determine which volume the host computer is using.

FIG. 4 shows an example of a list 40 of host names from which search engine 11 is going to retrieve files. The host names are registered by the administrator of search engine 11. Here, SAN_CLIENT_A 401 is the host name of SAN client A 12, and SAN_CLIENT_B 402 is the host name of SAN client B 13.

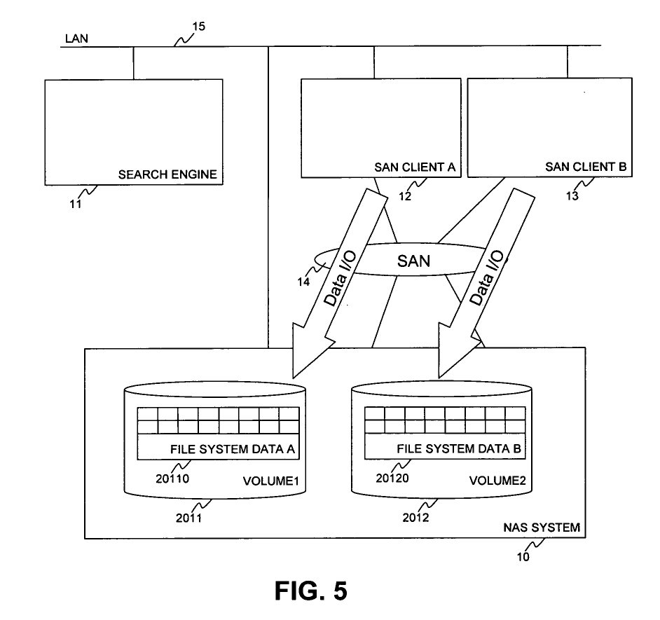

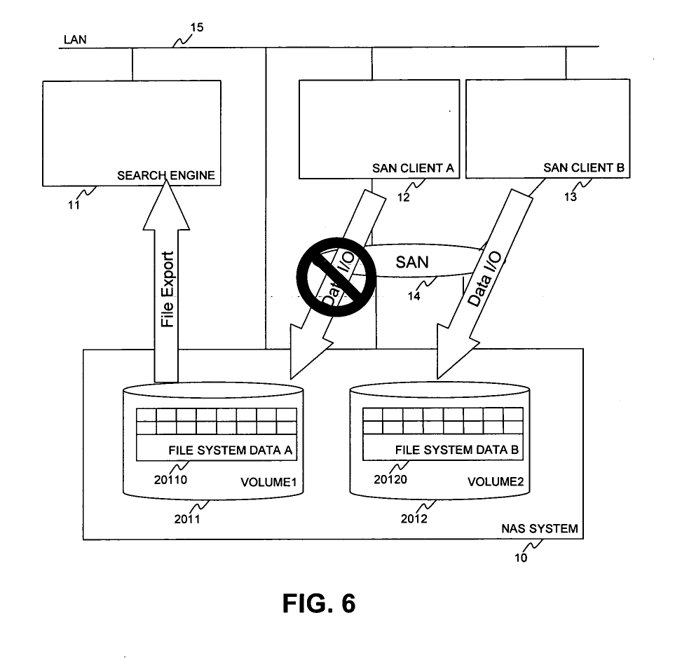

In the first embodiment, as in FIG. 5, SAN client A 12 is issuing I/O requests to volume 1 2011, and SAN client B 13 is issuing I/O requests to volume 2 2012 during normal operation. When search engine 11 retrieves files in volume 1 2011, as shown in FIG. 6, all the cached data on SAN client A is flushed, and all the I/O requests from SAN client A are suspended so that the consistency of the file system data is maintained during file retrieval.

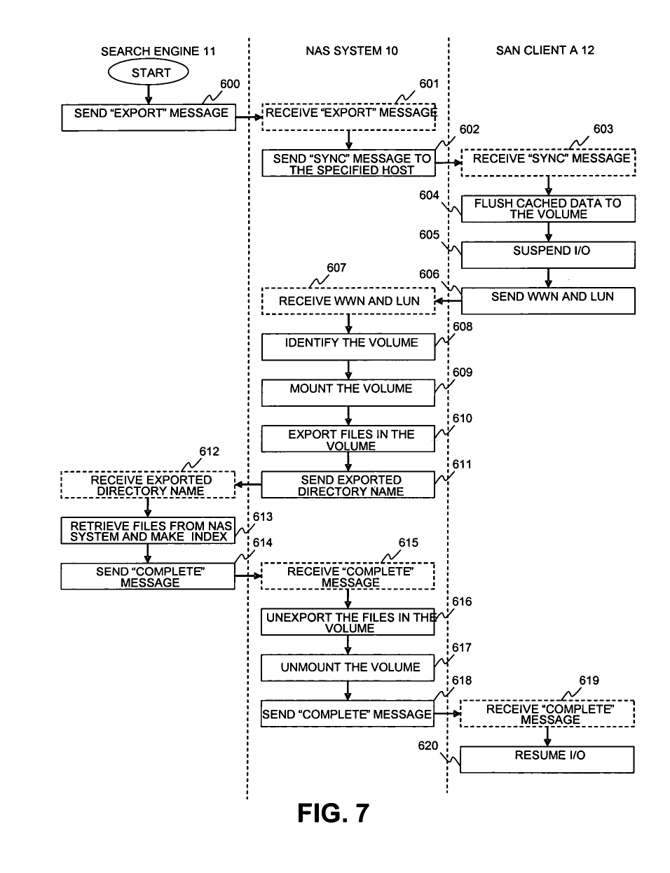

FIG. 7 shows the flow diagram of file retrieval from search engine 11 in the first embodiment. The steps shown in FIG. 7 will now be described in detail.

Step 600: file retriever 210 in search engine 11 sends “EXPORT” message to NAS system 10. Then, file retriever 210 sends the target host name (in this case “SAN_CLIENT A”) to NAS system 10 at the same time.

Step 601: file exporter 2003 in NAS system 10 receives “EXPORT” message from search engine 11.

Step 602: file exporter 2003 sends “SYNC” message to the host specified in the “EXPORT” message from search engine 11 (in this case “SAN client A 12”).

Step 603: sync agent 220 in SAN client A 12 receives “SYNC” message from NAS system 10.

Step 604: sync agent 220 instructs local file system A 221 to flush all the cached data to volume 1 2011.

Step 605: upon completion of flushing all the cached data to volume 1 2011, sync agent 220 instructs local file system A 221 to suspend all the I/O to volume 1 2011.

Step 606: upon completion of suspending all the I/O to volume 1 2011, sync agent 220 sends target WWN and LUN of the volumes that SAN client A 12 is using. In this case, SAN client A 12 sends back “10:00:00:00:00:00:00:01” for WWN and “1” for LUN.

Step 607: file exporter 2003 receives WWN and LUN from SAN client A 12.

Step 608: file exporter 2003 identifies the volume# of the volume by searching volume management table 30 for the WWN and LUN sent from SAN client A 12. In this case, volume# 1 (volume 1 2011) is identified from the column 301 of table 30.

Step 609: file exporter 2003 instructs multi-file system 2001 to mount volume 1 2011.

Step 610: upon completion of mounting volume 1 2011, file exporter 2003 instructs NFS/CIFS server 2000 to export files in volume 1 2011.

Step 611: upon completion of exporting files in volume 1 2011, file exporter 2003 sends “READY” message to search engine 11. Then, file exporter 2003 sends the exported directory name, which is the directory to which volume 1 2011 is mounted.

Step 612: file retriever 210 receives “READY” message and the exported directory name.

Step 613: file retriever 210 retrieves files from the directory exported by NFS/CIFS server 2000 and passes them to data indexer 211. Data indexer 211 makes indices for the files.

Step 614: upon completion of retrieving all the files exported by NFS/CIFS server 2000, file retriever 210 sends “COMPLETE” message to file exporter 2003.

Step 615: file exporter 2003 receives “COMPLETE” message from file retriever 210.

Step 616: file exporter 2003 instructs NFS/CIFS server 2000 to unexport files in volume 1 2011.

Step 617: upon completion of unexporting files in volume 1 2011, file exporter 2003 instructs multi-file system 2001 to unmount volume 1 2011.

Step 618: upon completion of unmounting volume 1 2011, file exporter 2003 sends “COMPLETE” message to SAN client A 12.

Step 619: Sync Agent 220 receives “COMPLETE” message from file exporter 2003.

Step 620: Sync Agent 220 instructs local file system A 221 to resume I/O to volume 1 2011.

### Second Embodiment

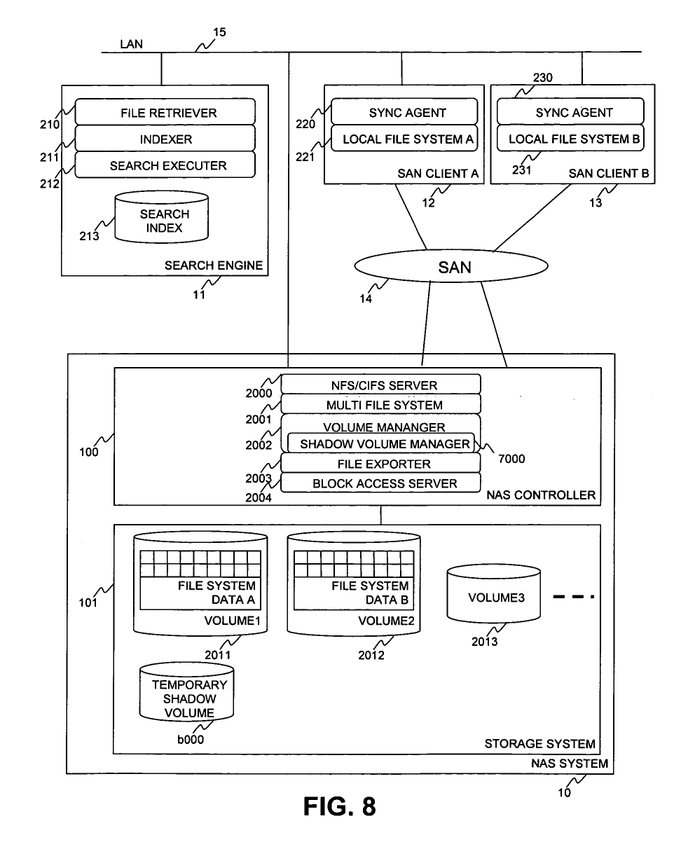

The system configuration of the second embodiment is the same as the first embodiment. FIG. 8 shows a functional diagram of the operation of the system according to the second embodiment. Search engine 11 and SAN clients 12 and 13 contain the same components as those in first embodiment. In NAS controller 10, there is shadow volume manager 7000 in addition to the components used in first embodiment. Also, file exporter 2003 plays some different roles in the second embodiment from those in the first embodiment.

File exporter 2003 receives the “EXPORT” message from file retriever 210 in search engine 11. Also, file exporter 2003 sends the “SYNC” message to sync agent 220 or 230 in SAN client 12 or 13. File exporter 2003 instructs shadow volume manager 7000 to prepare the shadow volumes of the volume and split the shadow volumes from volume A or B. File exporter 2003 instructs multi-file system 2001 to mount shadow volumes, and NFS/CIFS server 2000 to export files in the shadow volumes.

Shadow volume manager 7000 instructs in advance to volume manager 2000 to create a temporary shadow volume d000 using disk drives 1013 in storage system 101 in accordance with an instruction from file exporter 2003. Also, shadow volume manager 7000 prepares shadow volumes of volumes in accordance with an instruction from file exporter 2003. Also, shadow volume manager 7000 splits the shadow volumes in accordance with an instruction from file exporter 2003.

Shadow volume is a mechanism to take a point in time copy of a volume. One example is Hitachi's ShadowImage™, which is explained in greater detail at the following URL, the disclosure of which is hereby incorporated by reference: http://www.hds.com/products_services/services/productbased/shadowimage.html

There are various methods to implement the shadow volume mechanism. Mirroring is one of the most popular implementations. In the mirroring method, a volume (a shadow volume) that has the same size as the original volume is prepared, and the shadow volume is associated with the original volume. Immediately after the shadow volume is associated with the original volume, all the data in the original volume is copied to the shadow volume (initial copy). After the initial copy is completed, all the write I/O processes to the original volume are also applied to the shadow volume. When a data image in a certain time needs to be kept, applying write I/O processes to the shadow volume is stopped (splitting the shadow volume from the original volume).

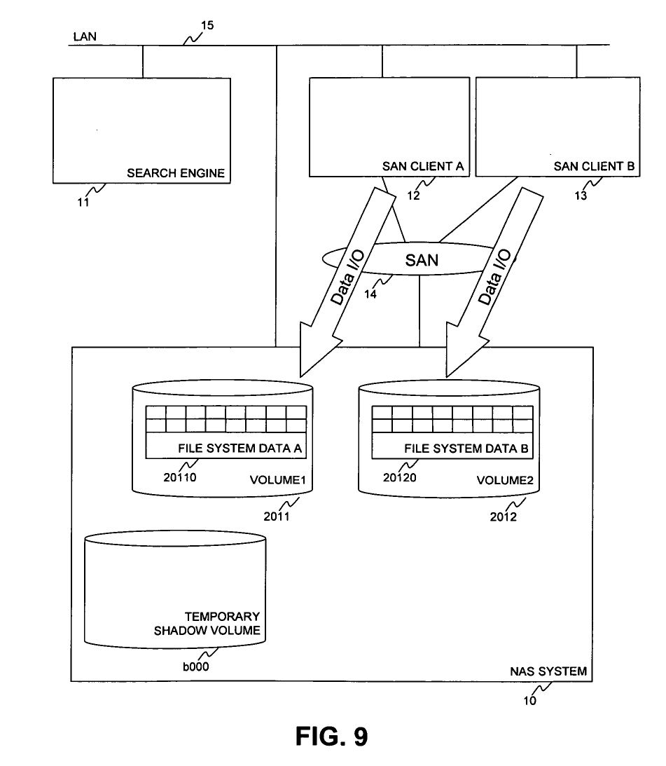

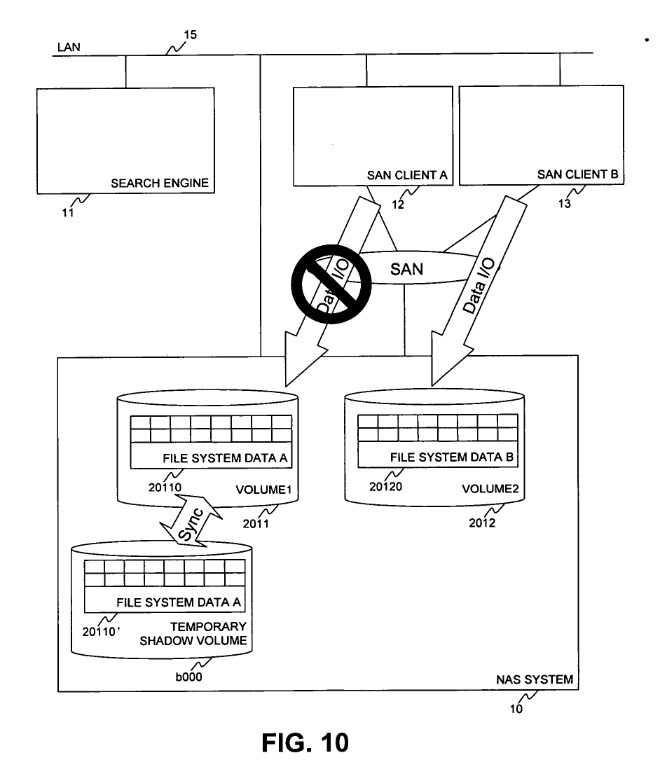

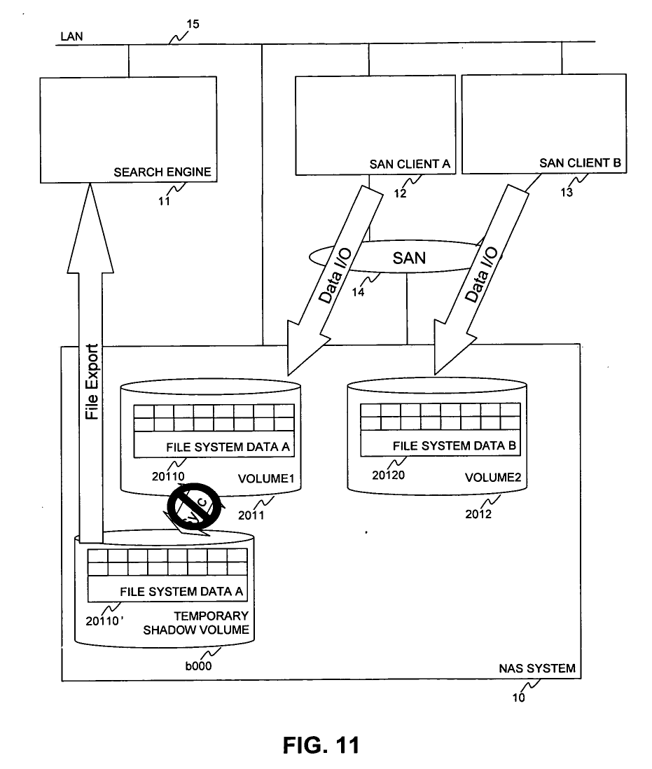

As shown in FIG. 9, during normal operation, SAN client A 12 is issuing I/O requests to volume 1 2011, and SAN client B 13 is issuing I/O requests to volume 2 2012. As in FIG. 10, before search engine 11 retrieves files in volume 1 2011, all the cached data on SAN client A is flushed, and all the I/O requests from SAN client A are suspended. Then shadow volume of volume 1 2011 is created in temporary shadow volume b000 and split from volume 1 2001, so that shadow volume b000 contains file system data A 20110′. After that, as in FIG. 11, SAN client A 12 resumes the I/O requests, search engine 11 starts retrieving files from temporary shadow volume b000.

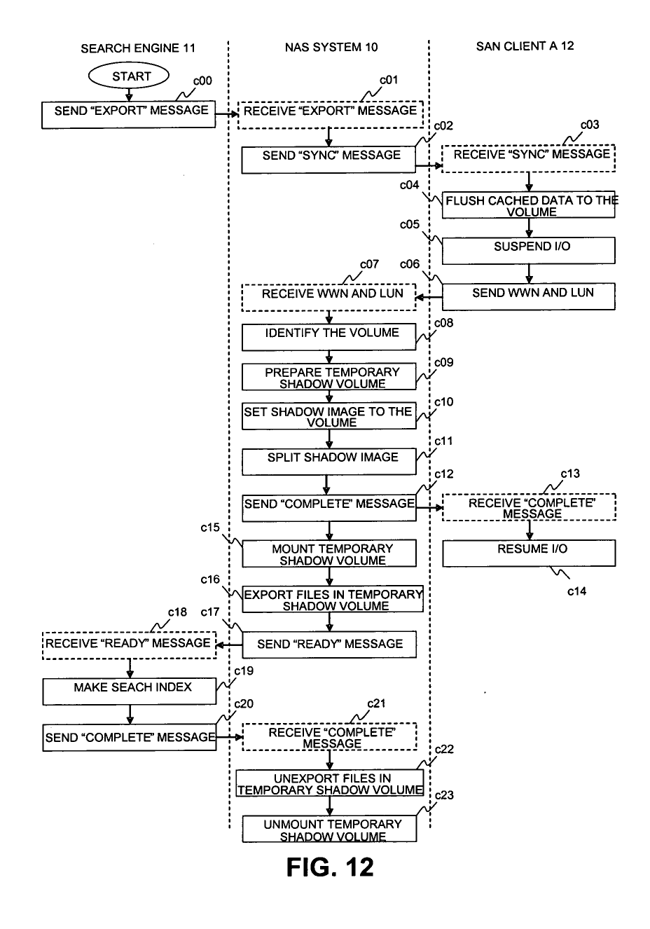

FIG. 12 shows the flow diagram of file retrieval from SAN client A 12 in the second embodiment.

Step c00: file retriever 210 in search engine 11 sends the “EXPORT” message to NAS system 10. Then, file retriever 210 sends the target host name (in this case “SAN_CLIENT A”) to NAS system 10 at the same time.

Step c01: file exporter 2003 in NAS system 10 receives the “EXPORT” message from search engine 11.

Step c02: file exporter 2003 sends the “SYNC” message to the host specified in the “EXPORT” message from search engine 11 (in this case “SAN client A 12”).

Step c03: sync agent 220 in SAN client A 12 receives the “SYNC” message from NAS system 10.

Step c04: sync agent 220 instructs local file system A 221 to flush all the cached data to volume 1 2011.

Step c05: upon completion of flushing all the cached data to volume 1 2011, sync agent 220 instructs local file system A 221 to suspend all the I/O processes to volume 1 2011.

Step c06: upon completion of suspending all the I/O to volume 1 2011, sync agent 220 sends target WWN and LUN of the volumes that SAN client A 12 is using. In this case, SAN client A 12 sends back “10:00:00:00:00:00:00:01” as WWN and “1” as LUN.

Step c07: file exporter 2003 in NAS system 10 receives WWN and LUN from SAN client A 12.

Step c08: file exporter 2003 identifies volume# of the volume by searching volume Management Table 30 for WWN and LUN sent from SAN client A 12. In this case, volume #1 (volume 1 2011) is identified from the column 301 of table 30.

Step c09: file exporter 2003 instructs volume manager 2002 to prepare temporary shadow volume b000 which has the same size as volume #1 (volume 1 2011).

Step c10: upon completion of preparing temporary shadow volume b000, file exporter 2003 instructs shadow volume manager 7000 to prepare shadow volume of volume 1 2011.

Step c11: upon completion of preparing shadow volume of volume 1 2011, file exporter 2003 instructs shadow volume manager 7000 to split the shadow volume in temporary volume b000 from volume 1 2011.

Step c12: file exporter 2003 sends “COMPLETE” message to SAN client A 12.

Step c13: sync agent 220 in SAN client A 12 receives “COMPLETE” message.

Step c14: sync agent 220 instructs local file system A 221 to resume I/O to volume 1 2011.

Step c15: file exporter 2003 instructs multi-file system 2001 to mount temporary shadow volume b000.

Step c16: upon completion of mounting temporary shadow volume b000, file exporter 2003 instructs NFS/CIFS server 2000 to export files in temporary shadow volume b000.

Step c17: upon completion of exporting files in temporary shadow volume b000, file exporter 2003 sends “READY” message to search engine 11. Then, file exporter 2003 sends the exported directory name, which is the directory to which the temporary shadow volume b000 is mounted.

Step c18: file retriever 210 receives “READY” message and the exported directory name.

Step c19: file retriever 210 retrieves files from the specified directory exported by NFS/CIFS server 2000 and passes them to data indexer 211. Data indexer 211 makes indices for the files.

Step c20: upon completion of retrieving all the files exported by NFS/CIFS server 2000, file retriever 210 sends “COMPLETE” message to file exporter 2003.

Step c21: file exporter 2003 receives “COMPLETE” message from file retriever 210.

Step c22: file exporter 2003 instructs NFS/CIFS server 2000 to unexport files in temporary shadow volume b000.

Step c23: upon completion of unexporting files in temporary shadow volume b000, file exporter 2003 instructs multi-file system 2001 to unmount temporary shadow volume b000.

### Third Embodiment

As with the second embodiment, the system diagram of the third embodiment is the same as the second embodiment.

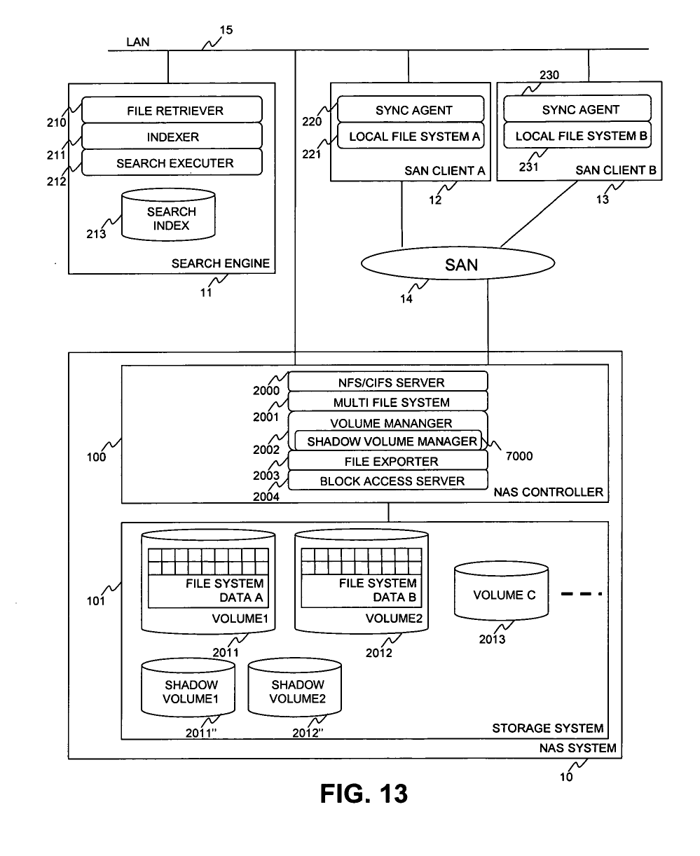

FIG. 13 shows a functional diagram of the system according to the third embodiment. The components used in the third embodiment are similar to those in the second embodiment. However, file retriever 210, file exporter 2003, and sync agent 220 play some different roles in third embodiment from those in the second embodiment.

File retriever 210 sends a “PREPARE” message to file exporter 2003 in advance of sending an “EXPORT” message. File exporter 2003 sends a “PROBE” message to Sync Agent 220. Also, file exporter 2003 instructs shadow volume manager 7000 to prepare shadow volumes 2011″ and 2012″ for each volume when receiving the “PREPARE” message from file retriever 210. When file exporter 2003 receives the “EXPORT” message from file retriever 210, file exporter 2003 instructs shadow volume manager 7000 to split the shadow volumes.

Sync agent 220 sends back WWN and LUN that the host is using when receiving “PROBE” message. Also, sync agent 220 instructs local file system A 221 to flush all the data cached in memory 121, and stop all the write I/O operations to the volumes in NAS system 10 when receiving the “SYNC” message from NAS system 10.

FIG. 15 shows an example of a table 80 to manage the volumes in storage system 101 in NAS system 10, according to this embodiment. The table 80 is managed by volume manager 2002. In addition to the items in the table 30 in first and second embodiments, there is a shadow volume# column 350.

Shadow volume# column 350 shows the volume# that is associated with the volume as the shadow volume. In this case, volume 1 2011 (volume #1 301) has volume #21 (Shadow volume 1 2011″) as the shadow volume, and volume 2 2012 (volume #2 301) has volume #22 (Shadow volume 2 2012″) as the shadow volume. Also rows 305 and 306 are shown on table 80 so that volumes #21 and #22, respectively are accounted for in the table.

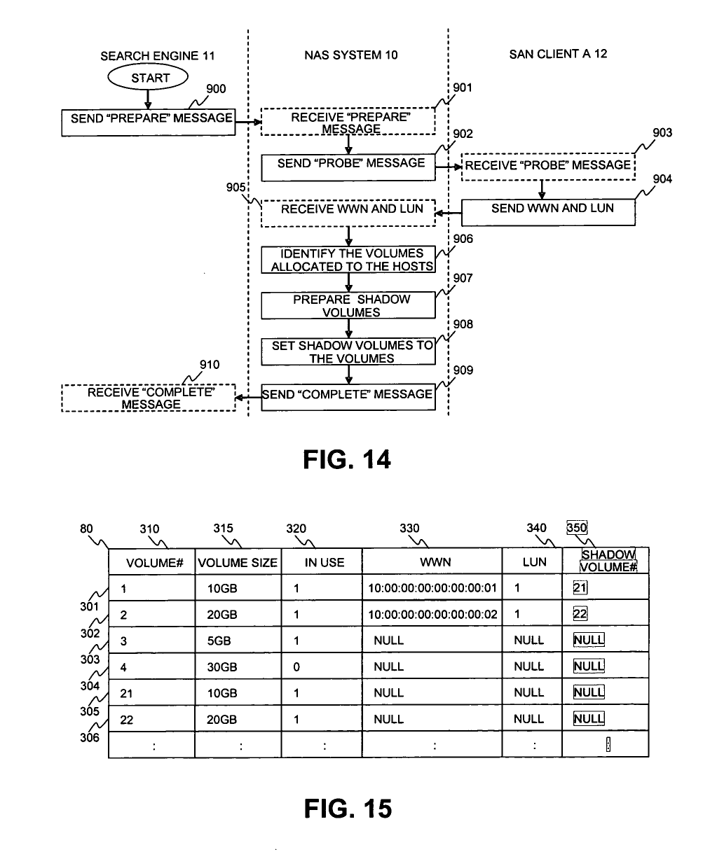

FIG. 14 shows the flow diagram of preparation, which was discussed earlier. Before search engine 11 sends “EXPORT” message to NAS system 10, search engine 11 sends “PREPARE” message to NAS system 10. NAS system 10 prepares shadow volume 1 2011″ and shadow volume 2 2012″ in accordance with the message. The flow is as follows:

Step 900: file retriever 210 in search engine 11 sends “PREPARE” message to NAS system 10. Then, file retriever 210 sends the target host name (in this case “SAN_CLIENT_A”) to NAS system 10 at the same time.

Step 901: file exporter 2003 receives “PREPARE” message from search engine 11.

Step 902: file exporter 2003 sends “PROBE” message to SAN client A 12.

Step 903: Sync Agent 220 in SAN client A 12 receives “PROBE” message from NAS system 10.

Step 904: Sync Agent 220 sends target WWN and LUN of the volumes that SAN client A 12 is using. In this case, SAN client A 12 sends back “10:00:00:00:00:00:00:01” for WWN and “1” for LUN.

Step 905: file exporter 2003 in NAS system 10 receives WWN and LUN from SAN client A 12

Step 906: file exporter 2003 identifies the volume# of the volume by searching volume management table 80 for WWN and LUN sent from SAN client A 12. In this case, volume #1 (volume 1 2011) is identified from the column 301 of table 80.

Step 907: file exporter 2003 instructs volume manager 2002 to prepare shadow volume 1 2011″ which has the same size as volume #1 (volume 1 2011). In this case, volume #21 is used for shadow volume 1 2011″.

Step 908: file exporter 2003 instructs shadow volume manager 7000 to prepare a shadow volume of volume 1 2011 using shadow volume 1 2011″. Then, shadow volume manager 7000 adds the volume# of shadow volume 1 2011 to volume management table 80. In this case, volume #21 is set as shadow volume# in column 301 of table 80.

Step 909: upon completion of preparing the shadow volume, file exporter 2003 sends “COMPLETE” message to search engine 11.

Step 910: file retriever 210 receives “COMPLETE” message from file exporter 2003.

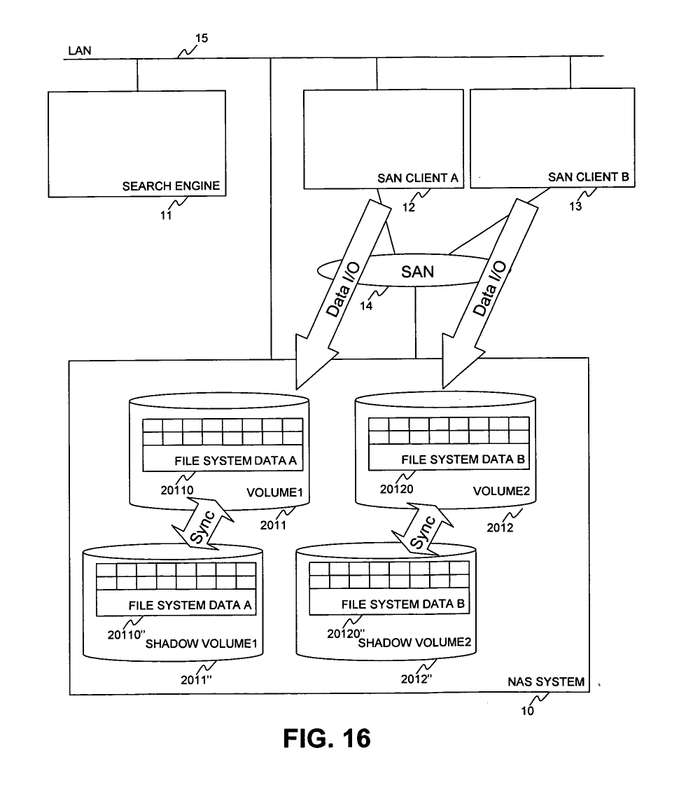

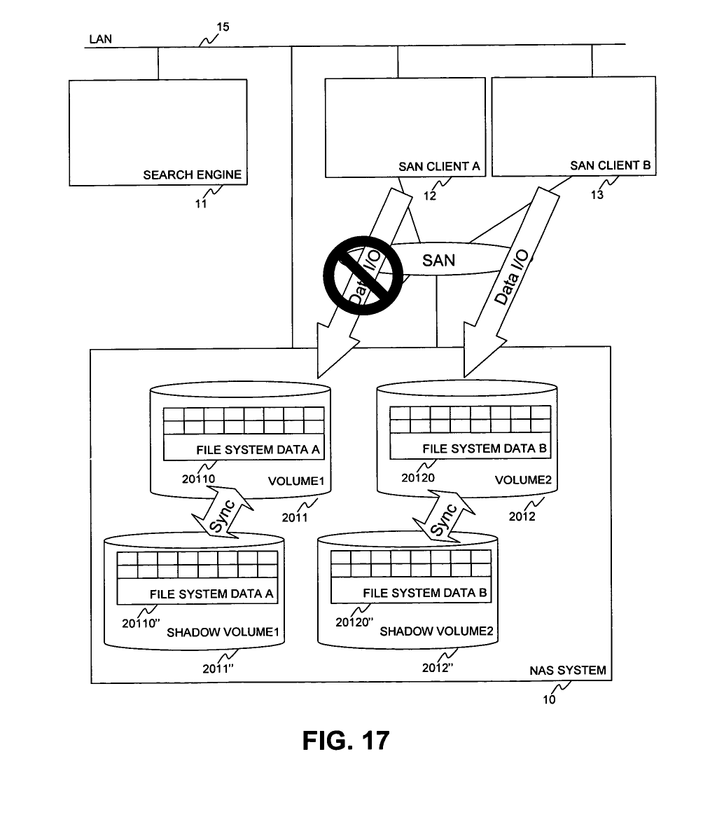

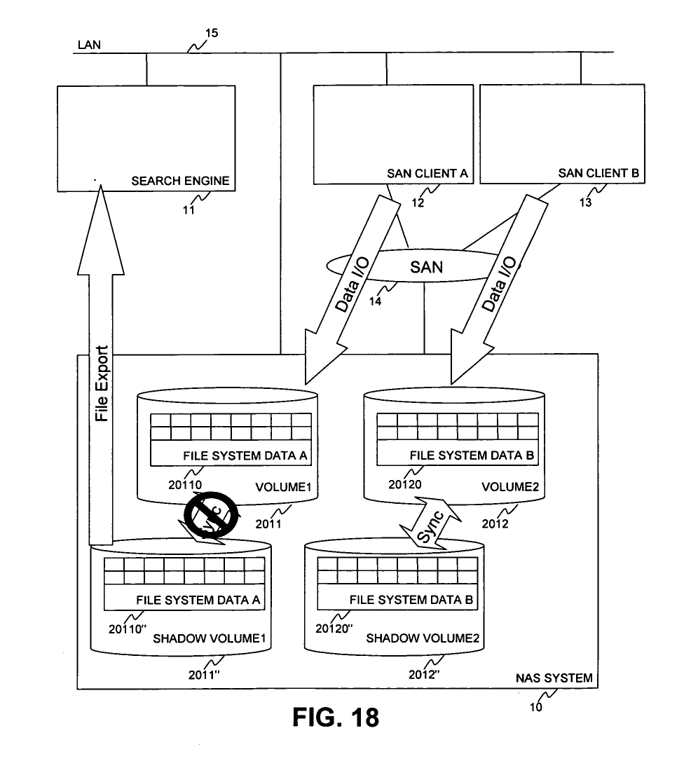

As in FIG. 16, during normal operation, SAN client A 12 is issuing I/O requests to volume 1 2011, and SAN client B 13 is issuing I/O requests to volume 2 2012. Like in FIG. 17, before search engine 11 retrieves files in volume 1 2011, all the cached data on SAN client A is flushed, and all the I/O requests from SAN client A are stopped. Then, as shown in FIG. 18, shadow volume of volume 1 2011 in Shadow volume 1 2011″ is split from volume 1 2001, with shadow volume 1 2011″ containing file system data A 20110″. After that, NAS system 10 sends a “COMPLETE” message to SAN client A 12, and SAN client A 12 resumes the I/O requests. Also, NAS system 10 sends “READY” message to search engine 11, and search engine 11 starts retrieving files from Shadow volume 4 2011″.

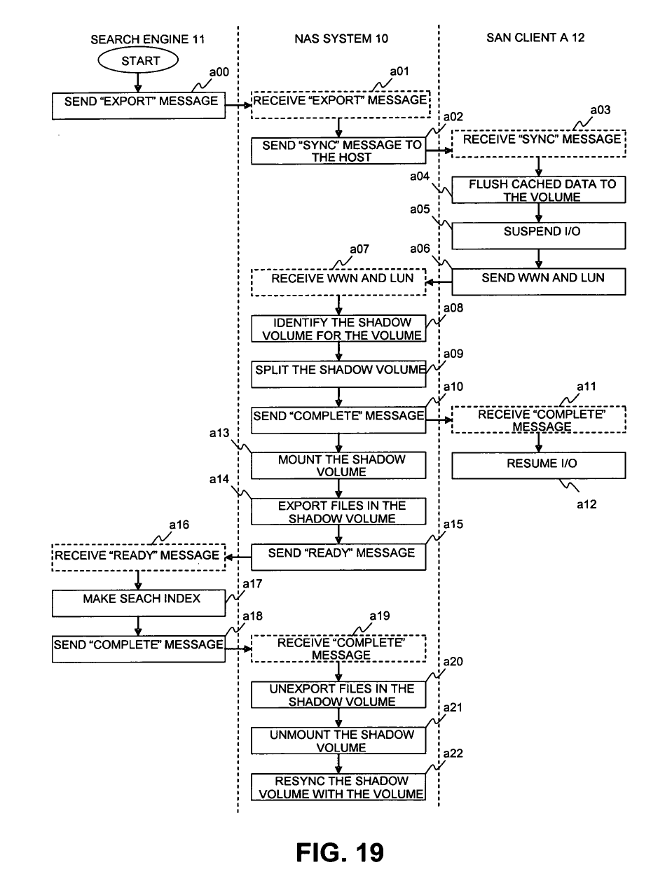

FIG. 19 shows the flow diagram of file retrieval from SAN client A 12 in 3rd embodiment.

Step a00: filer retriever 210 in search engine 11 sends “EXPORT” message to NAS system 10. Then, file retriever 210 sends the target host name (in this case “SAN_CLIENT_A”) to NAS system 10 at the same time.

Step a01: file exporter 2003 in NAS system 10 receives “EXPORT” message from search engine 11.

Step a02: file exporter 2003 sends “SYNC” message to the host specified in the “EXPORT” message from search engine 11 (in this case “SAN client A 12”).

Step a03: sync agent 220 in SAN client A 12 receives “SYNC” message from NAS system 10.

Step a04: sync agent 220 instructs local file system A 221 to flush all the cached data to volume 1 2011.

Step a05: upon completion of flushing all the cached data to volume 1 2011, sync agent 220 instructs local file system A 221 to suspend all the I/O to volume 1 2011.

Step a06: sync agent 220 sends target WWN and LUN of the volumes that SAN client A 12 is using. In this case, SAN client A 12 sends back “10:00:00:00:00:00:00:01” as WWN and “1” as LUN.

Step a07: file exporter 2003 in NAS system 10 receives WWN and LUN from SAN client A 12

Step a08: file exporter 2003 identifies volume# of the shadow volume that is associated to the volume the SAN client A 12 is using by searching volume Management Table 80 for WWN and LUN sent from SAN client A 12. In this case, volume #21 (Shadow volume 1 2011″) is identified from the column 801.

Step a09: file exporter 2003 instructs Shadow volume Manager 7000 to split the shadow volume in Shadow volume 1 2011″ from volume 1 2011.

Step a10: upon completion of splitting shadow volume, file exporter 2003 sends “COMPLETE” message to SAN client A 12.

Step a11: sync agent 220 in SAN client A 12 receives “COMPLETE” message.

Step a12: sync agent 220 instructs local file system A 221 to resume I/O to volume 1 2011.

Step a13: file exporter 2003 instructs multi-file system 2001 to mount shadow volume 1 2011″.

Step a14: upon completion of mounting shadow volume 1 2011″, file exporter 2003 instructs NFS/CIFS server 2000 to export files in Shadow volume 1 2011″.

Step a15: upon completion of exporting files in shadow volume 1 2011″, file exporter 2003 sends “READY” message to search engine 11. Then, file exporter 2003 sends the exported directory name, which is the directory that the shadow volume 1 2011″ is mounted to.

Step a16: file retriever 210 receives “READY” message and the exported directory name.

Step a17: file retriever 210 retrieves files from the specified directory exported by NFS/CIFS server 2000 and passes them to data indexer 211. Data indexer 211 makes indices for the files.

Step a18: upon completion of retrieving all the files exported by NFS/CIFS server 2000, file retriever 210 sends “COMPLETE” message to file exporter 2003.

Step a19: file exporter 2003 receives “COMPLETE” message from file retriever 210.

Step a20: file exporter 2003 instructs NFS/CIFS server 2000 to unexport files in shadow volume 1 2011″

Step a21: upon completion of unexporting files in shadow volume 1 2011″, file exporter 2003 instructs multi-file system 2001 to unmount shadow volume 1 2011″.

Step a22: upon completion of unmounting shadow volume 1 2011″, file exporter 2003 instructs Shadow volume Manager 7000 to resync the shadow volume in Shadow volume 1 2011″ with volume 1 2011.

With the various embodiments described above, the present invention relieves the burden upon host systems that have to suspend operations while providing volumes for search engines and lets them function more efficiently.

While specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

The invention claimed is:

1. A method of providing search information to a search engine in a system having a network attached storage (NAS) system connected to a plurality of storage area network (SAN) clients, comprising the steps of:
receiving a search request from the search engine for a first volume stored in a first SAN client;
suspending all I/O operations, from a file system controlling said first volume, to said first volume;
mounting said first volume in a NAS controller of said NAS system; and
informing said search engine of the location of said mounted first volume so that said search engine can access said first volume in said NAS controller.

2. The method according to claim 1, wherein in response to said step of receiving a search request, said NAS system sends a command to said first SAN client.

3. The method according to claim 2, wherein in response to receiving said command from said NAS system, said first SAN client flushes all cached data to said first volume.

4. The method according to claim 2, wherein in response to receiving said command from the NAS system, the first SAN client sends WWNs and LUNs of volumes that the first SAN client is using.

5. The method according to claim 4, wherein the NAS system identifies said first volume requested by the search request by referring to the WWNs and LUNs sent by the first SAN client before mounting said first volume.

6. The method according to claim 1, wherein said step of informing the search engine includes the step of providing directory information of said first volume mounted by said NAS controller.

7. The method according to claim 1, wherein after said step of informing said search engine, and after said search engine has accessed said first volume, said NAS system unmounts said first volume and sends a message to said first SAN client to resume I/O operations to said first volume.

8. The method according to claim 1, wherein a second SAN client different from said first SAN client can continue normal operations with the NAS system while said first volume mounted by said NAS system is accessed by said search engine.

9. A method of providing search information to a search engine in a system having a network attached storage (NAS) system connected to a plurality of storage area network (SAN) clients, comprising the steps of:
receiving a search request from the search engine for files stored in a first volume used by a first SAN client;
suspending all I/O operations from said first SAN client to said first volume;
preparing a temporary shadow volume of said first volume in said NAS system;
splitting said shadow volume from said first volume;
instructing said first SAN client to resume I/O operations;
mounting the shadow volume;
informing said search engine of the location of said shadow volume so that said search engine can access said shadow volume in said NAS system.

10. The method according to claim 9, wherein in response to said step of receiving a search request, said NAS system sends a command to said first SAN client.

11. The method according to claim 10, wherein in response to receiving said command from said NAS system, said first SAN client instructs said file system to flush all cached data to said first volume.

12. The method according to claim 10, wherein in response to receiving said command from the NAS system, the first SAN client sends WWNs and LUNs of volumes that the first SAN client is using.

13. The method according to claim 12, wherein the NAS system identifies said first volume requested by the search request by referring to the WWNs and LUNs sent by the first SAN client before preparing said shadow volume.

14. The method according to claim 9, wherein said step of informing the search engine includes the step of providing directory information of said shadow volume.

15. The method according to claim 9, wherein after said step of informing said search engine, and after said search engine has accessed said shadow volume, said NAS system unmounts said shadow volume.

16. The method according to claim 9, wherein a second SAN client different from said first SAN client can continue normal operations with the NAS system while said shadow volume is accessed by said search engine.

17. A method of providing search information to a search engine in a system having a network attached storage (NAS) system connected to a plurality of storage area network (SAN) clients, the NAS system including a shadow function whereby shadow volumes exist for at least some of the volumes in the storage system, said method comprising the steps of:
receiving a search request from the search engine for a first volume stored in a first SAN client, said first volume having a shadow volume;
suspending all I/O operations to said first volume from a first SAN client that uses said first volume;
splitting said shadow volume from said first volume;
instructing said first SAN client to resume I/O operations;
mounting the shadow volume;
informing said search engine of the location of said shadow volume so that said search engine can access said shadow volume in said NAS system.

18. The method according to claim 17, wherein in response to said step of receiving a search request, said NAS system sends a command to said first SAN client.

19. The method according to claim 18, wherein in response to receiving said command from said NAS system, said first SAN client instructs said file system to flush all cached data to said first volume.

20. The method according to claim 18, wherein in response to receiving said command from the NAS system, the first SAN client sends WWNs and LUNs of volumes that the first SAN client is using.

21. The method according to claim 20, wherein the NAS system resynchronizes the shadow volume with the first volume after the search engine has finished accessing the shadow volume.

22. The method according to claim 17, wherein said step of informing the search engine includes the step of providing directory information of said shadow volume.

23. The method according to claim 17, wherein after said step of informing said search engine, and after said search engine has accessed said temporary shadow volume, said NAS system unmounts said shadow volume.

24. The method according to claim 17, wherein a second SAN client different from said first SAN client can continue normal operations with the NAS system while said shadow volume is accessed by said search engine.
